(19) United States
(12) Patent Application Publication
(10) Pub. No.: US 2012/0037637 A1
(43) Pub. Date: Feb. 16, 2012

(54) DISPENSING DEVICES, SYSTEMS, AND METHODS THEREOF

(76) Inventors: Jeffrey J. Beyda, Brooklyn, NY (US); David Beyda, Brooklyn, NY (US)

(21) Appl. No.: 13/028,906

(22) Filed: Feb. 16, 2011

Related U.S. Application Data
(60) Provisional application No. 61/306,390, filed on Feb. 19, 2010.

(51) Int. Cl. B65F 1/06; B65D 55/00; B65F 1/16; B65D 43/26

(52) U.S. Cl. 220/495.11; 220/495.06; 220/264; 220/211

(57) ABSTRACT

The invention generally relates to devices, systems and methods for storing and dispensing of a trash bag from the side and/or top of a trash dispenser. More specifically, the devices, systems, and methods disclose trash dispenser that can include at least one sidewall extending vertically from a base, a first opening that can be substantially blocked by a lid, and a second opening that can be substantially blocked by a gate. The first opening can be located at the top of trash dispenser and can be for receiving and/or removing rubbish and/or trash bags. The second opening can be located on at least one sidewall of the second opening and can be for removing and/or receiving trash bags. Further, by displacing the lid and gate, substantially un-blocking the first opening and second opening, trash bags can be laterally removed from the trash dispenser and/or can be removed without being required to be lifted solely vertically.

### CROSS-REFERENCE TO RELATED APPLICATIONS

This application claims priority to U.S. Provisional Patent Application No. 61/306,390, Feb. 19, 2010, the content of which is incorporated herein by reference in its entirety.

### FIELD OF INVENTION

The present invention relates to dispensing devices, systems, and methods that can be used to allow a bag or other internal receptacle to be laterally removed and/or removed without being required to be lifted solely vertically.

### SUMMARY OF THE INVENTION

In exemplary embodiments, a dispenser system, such as a trash dispenser system, can comprise a sidewall(s) extending a vertical length from a base. The trash dispenser system can also comprise a lid(s) that can substantially cover a first opening(s) and the first opening(s) can be located substantially near the top of the sidewall(s), wherein displacing the lid(s) can expose the first opening(s). Further, the trash dispenser system can also comprise a gate(s) that can substantially cover a second opening(s), the second opening(s) can be located along at least some region of the vertical length of the sidewall(s), wherein displacing the gate(s) can expose the second opening(s). Further, the first opening(s) and/or the second opening(s) can receive a receptacle, such as a trash bag, displacing the lid(s) can allow receipt of rubbish or other materials via the first opening(s), and/or displacing the gate(s) can allow substantially lateral removal of trash bags from the trash dispenser.

In exemplary embodiments, the gate can further comprise door(s) coupled to the sidewall(s) by hinge(s). Further, the gate can be a saloon style gate.

In exemplary embodiments, the cross-section of the trash dispenser can be square, rectangular, oval, and/or round.

In exemplary embodiments, the gate(s) can substantially replaces (i) a region of the sidewall of the trash dispenser and/or (ii) the sidewall of the trash dispenser. In exemplary embodiments, the substantially lateral removal of trash bags from the trash dispenser can allow removal of trash bags from the trash dispenser, for example, at an offset angle from the sidewall(s) and/or the base of the trash dispenser.

In exemplary embodiments, the lid(s) can be coupled to the sidewall(s) and/or removable from the sidewall(s). Further, the lid(s) can be coupled to the sidewall(s) by a hinge(s).

In exemplary embodiments, the lid(s) can be further comprise displaceable opening(s). Further, the displaceable opening(s) can be coupled to the lid(s) and/or the sidewall(s) by a hinge(s).

In exemplary embodiments, the trash dispenser can further comprise a force input(s), wherein displacing the lid(s), gate(s), and/or displaceable opening(s) can be activated by the force input(s). In some instances, the force input can be a lever, a foot pedal, and/or a button. Also, in some instances, the force input can be a motor. Further, in exemplary embodiments, the trash dispenser can further comprise a sensor(s); wherein the motor can be activated in response to the sensor.

In exemplary embodiments, the trash dispenser can further comprise a trash bag retaining region and/or trash bag attachment fixture. In some instances, the trash bag attachment fixture can further comprise hook(s) and loop(s), hook(s), clasp(s), adhesive(s), and/or rod(s). In some instances, the trash bag retaining region can retain the trash bag by, for example, wrapping a portion of the trash bag over a portion of the trash dispenser. Also, in some instances, the trash bag retaining region can retain the trash bag by, for example, wrapping a portion of the trash bag over a periphery of first opening(s).

### BRIEF DESCRIPTION OF DRAWINGS

The features and advantages of the invention will be more fully understood with reference to the following description of the disclosure when taken in conjunction with the accompanying figures, wherein:

FIGS. 1A-2C illustratively depict exemplary trash dispensers including a gate and lid that can open and close, in accordance with exemplary embodiments of the present invention;

FIGS. 3A-3B illustratively depict a top, front perspective view of exemplary trash dispensers with the gate closed and lid closed, in accordance with exemplary embodiments of the present invention;

FIGS. 4A-4B illustratively depict a front view of exemplary trash dispensers with the gate closed and lid closed, in accordance with exemplary embodiments of the present invention;

FIGS. 5A-5B illustratively depict a rear view of exemplary trash dispensers with the gate closed and lid closed, in accordance with exemplary embodiments of the present invention;

FIGS. 6A-6B illustratively depict a side view of exemplary trash dispensers with the gate closed and lid closed, in accordance with exemplary embodiments of the present invention;

FIGS. 7A-7B illustratively depict an opposite side view of exemplary trash dispensers with the gate closed and lid closed, in accordance with exemplary embodiments of the present invention;

FIGS. 8A-8B illustratively depict a top view of exemplary trash dispensers with the gate closed and lid closed, in accordance with exemplary embodiments of the present invention;

FIGS. 9A-9B illustratively depict a bottom view of exemplary trash dispensers with the gate closed and lid closed, in accordance with exemplary embodiments of the present invention;

FIGS. 10A-10D illustratively depict a top, front perspective view of exemplary trash dispensers with the gate closed and lid open, for example, exemplifying trash being placed in a trash bag housed in exemplary trash dispensers, in accordance with exemplary embodiments of the present invention; and

FIGS. 11A-11D illustratively depict a top, front perspective view of exemplary trash dispensers with the gate open and lid open, for example, exemplifying how trash bag can be removed and/or replaced from exemplary trash dispensers, in accordance with exemplary embodiments of the present invention.

### DETAILED DESCRIPTION

The present disclosure generally relates to devices, systems and methods for storing and dispensing a trash bag from the side and/or top of a trash dispenser.

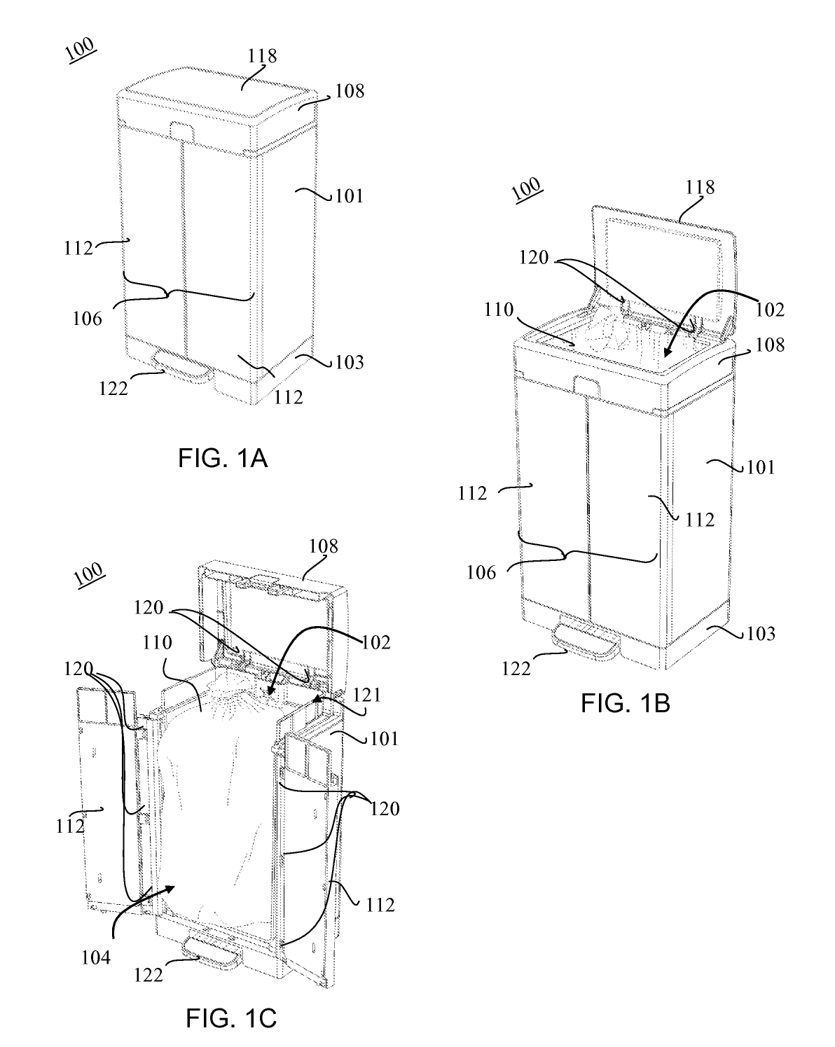

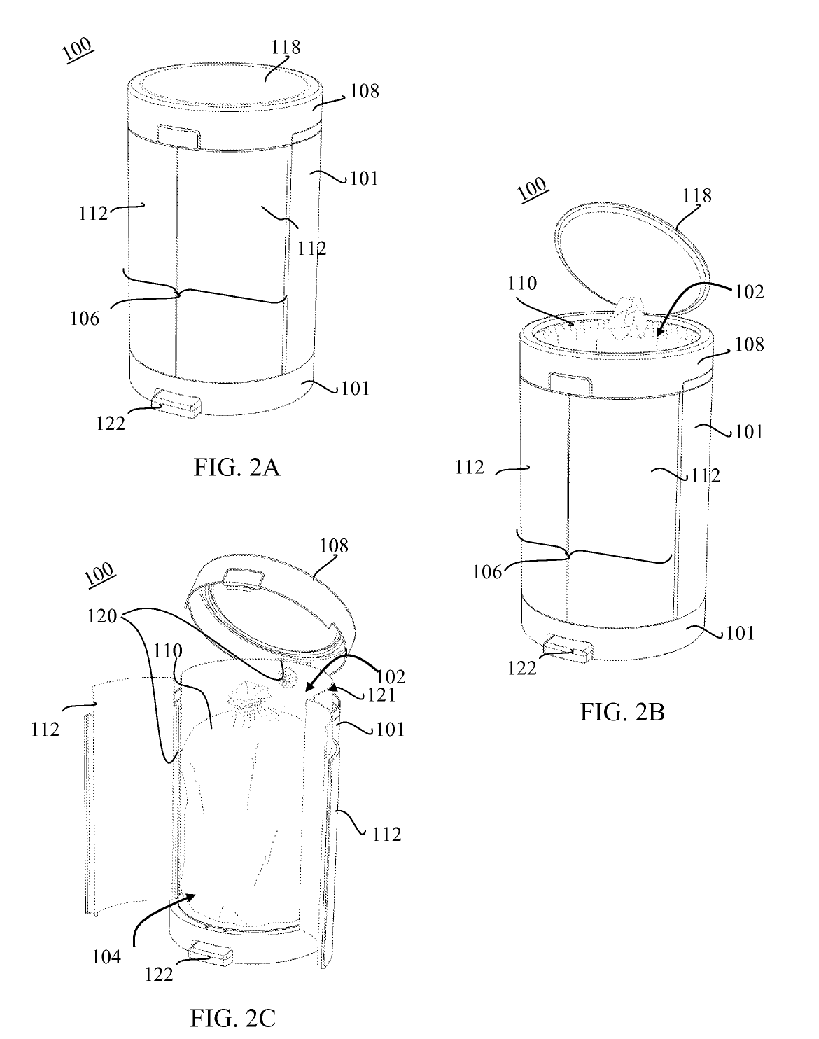

Referring to FIGS. 1A-2C, in exemplary embodiments, a trash dispenser 100 can include an at least one sidewall 101 extending vertically from a base 103 as well as include a first opening 102 that can be located substantially at the top of trash dispenser 100 and/or second opening 104 that can be located on an at least region of at least one sidewall 101 of trash dispenser 100.

In exemplary embodiments, first opening 102 can be for receiving and/or removing rubbish and/or a trash bag 110 from trash dispenser 100. Second opening 104 can be for removing trash bag 110 from trash dispenser 100 and/or receiving trash bag 110 into trash dispenser 100. Further, trash dispenser 100 can include an at least one gate 106 that can substantially block second opening 104 and/or trash dispenser 100 can include an at least one lid 108 that can substantially cover first opening 102.

Further, as discussed below, trash dispenser 100 can include and/or be affiliated with at least one door 112, at least one displaceable opening 118, at least one hinge 120, at least one trash bag retaining region 121, at least one trash bag attachment fixture (not shown) and/or a force input, for example, a foot pedal 122.

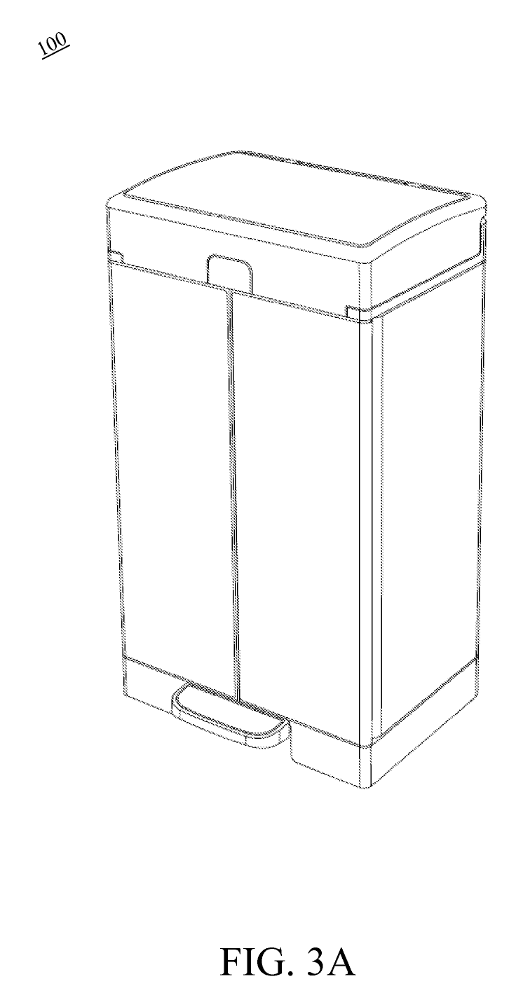

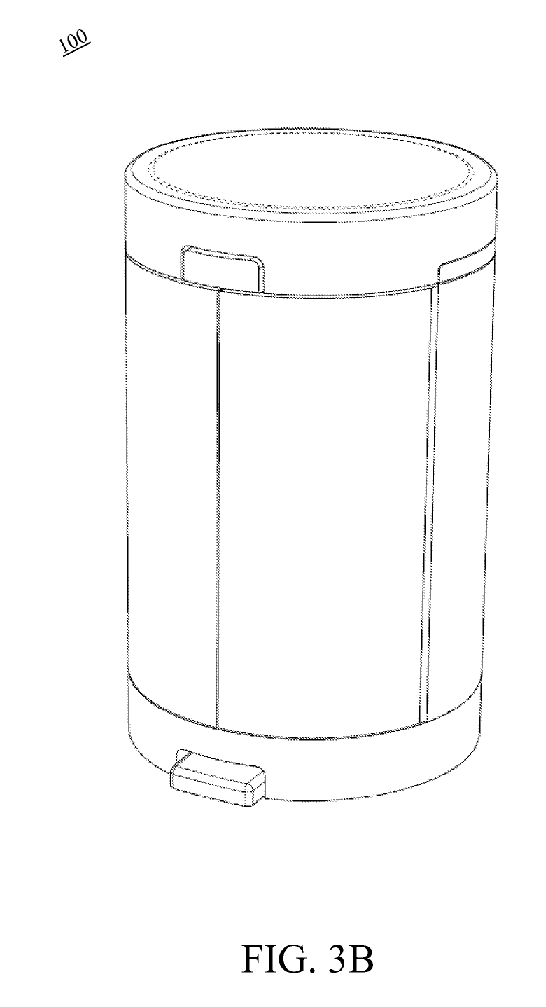

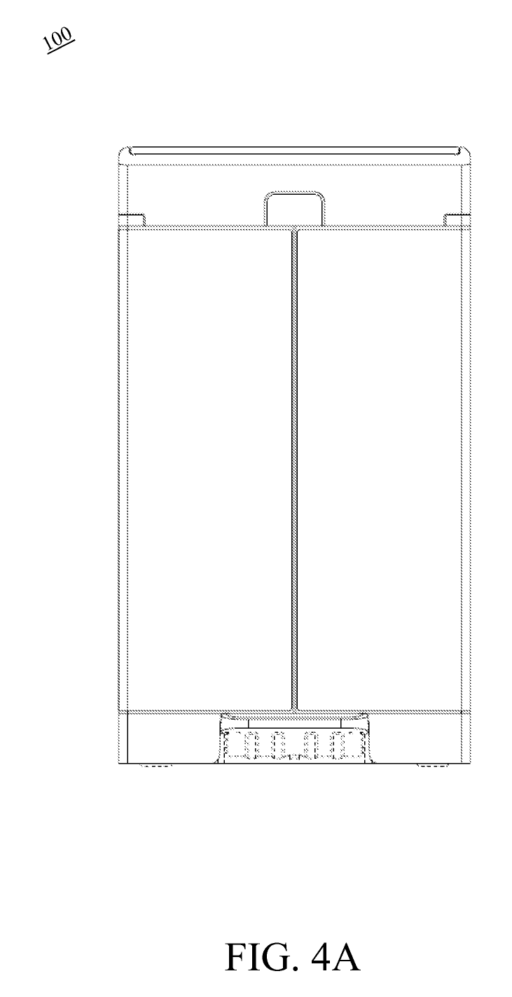

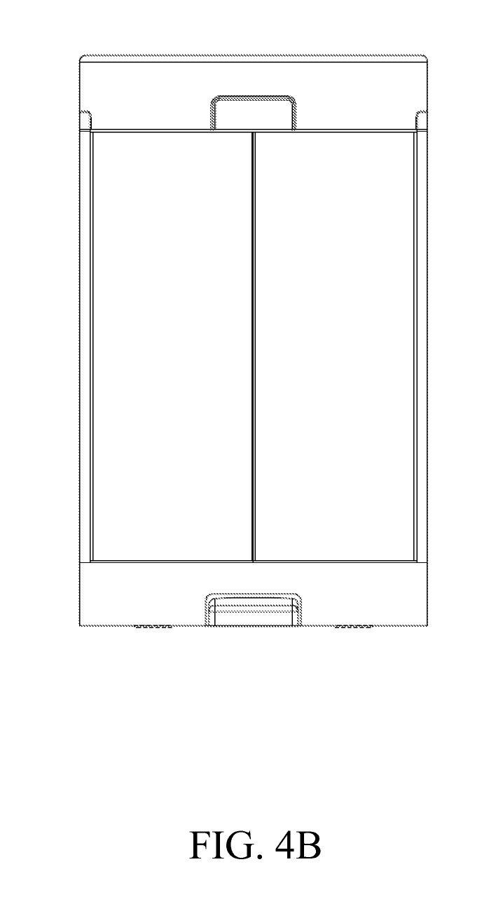

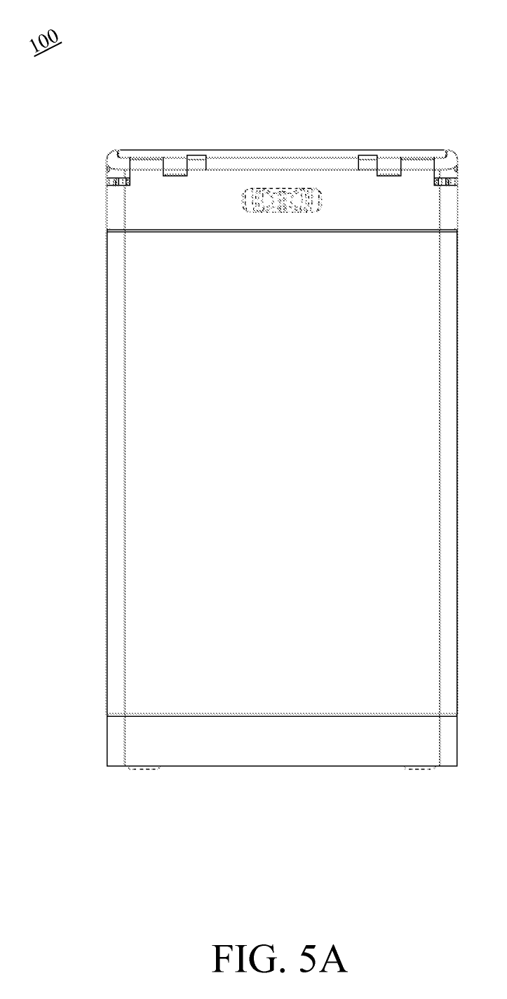

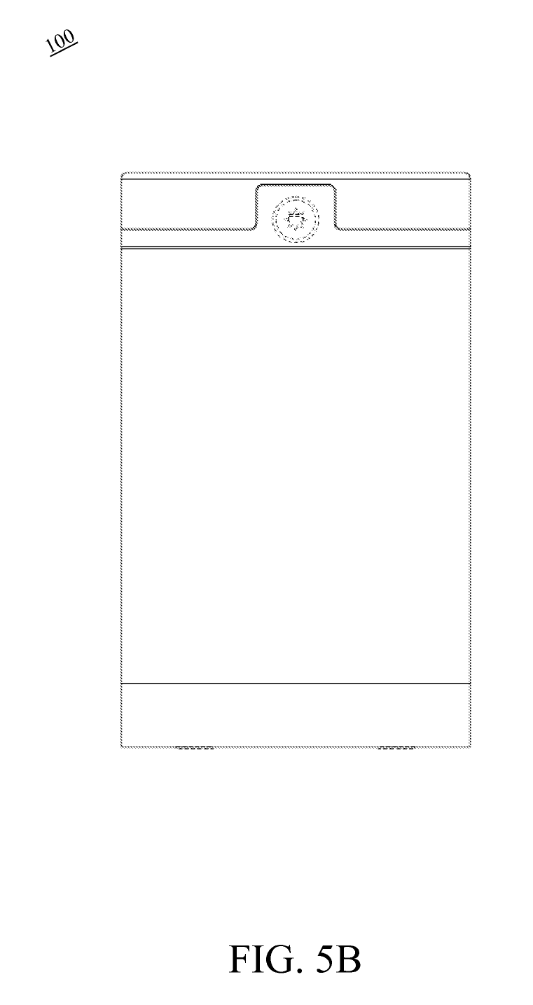

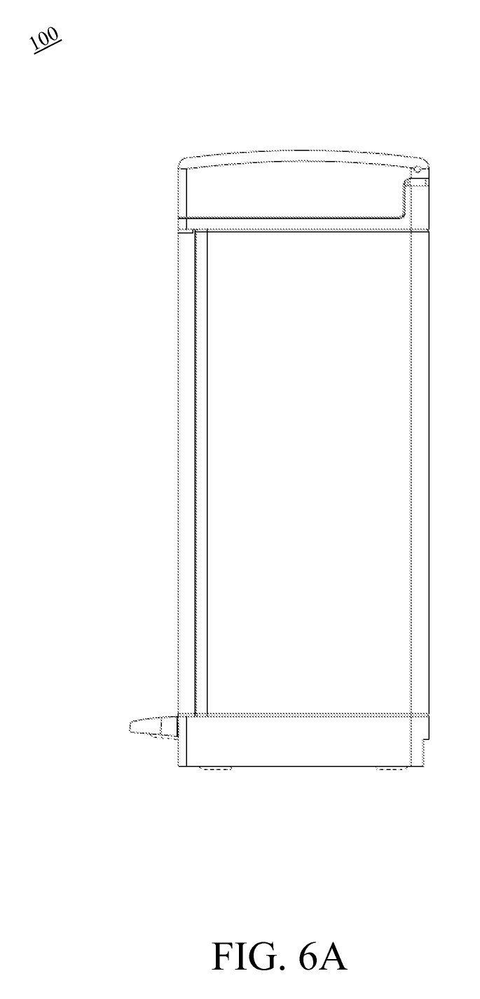

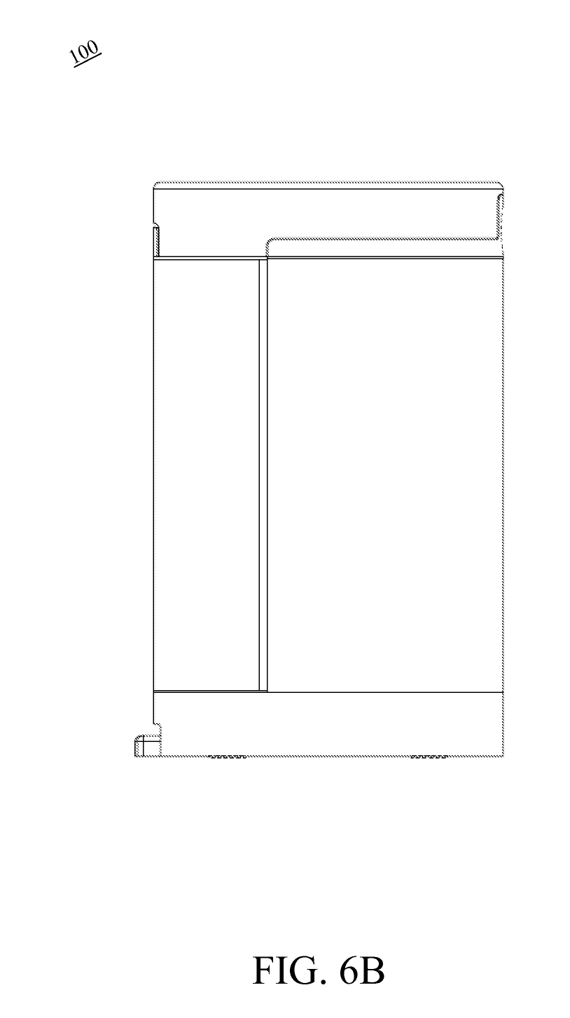

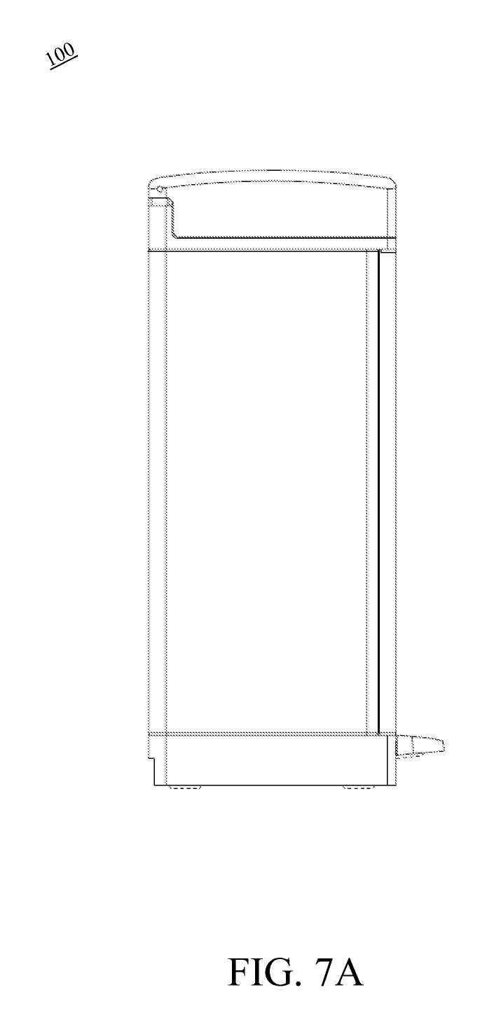

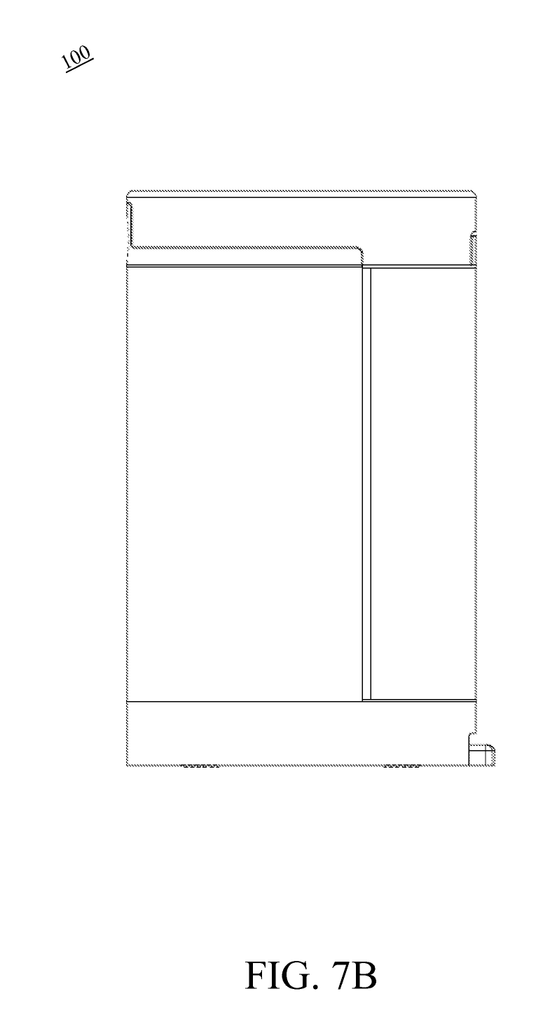

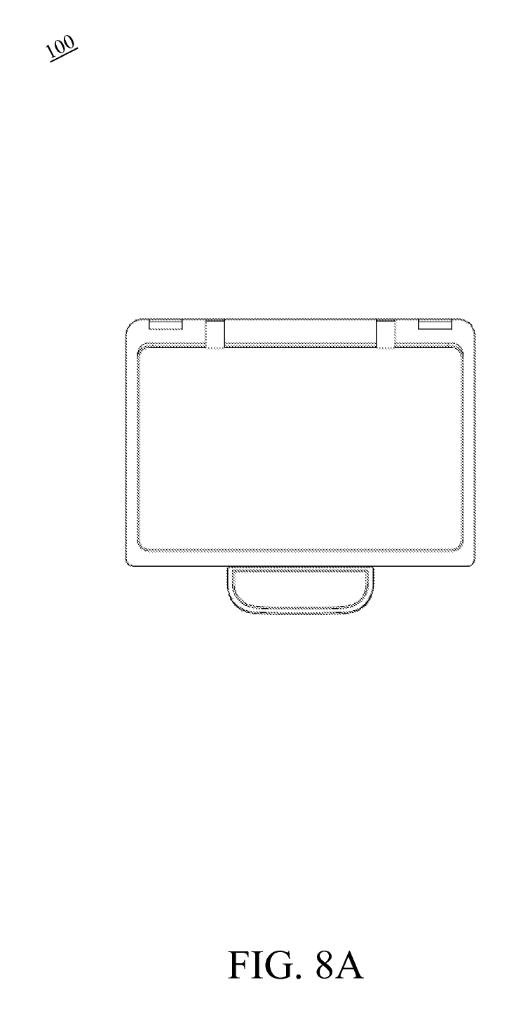

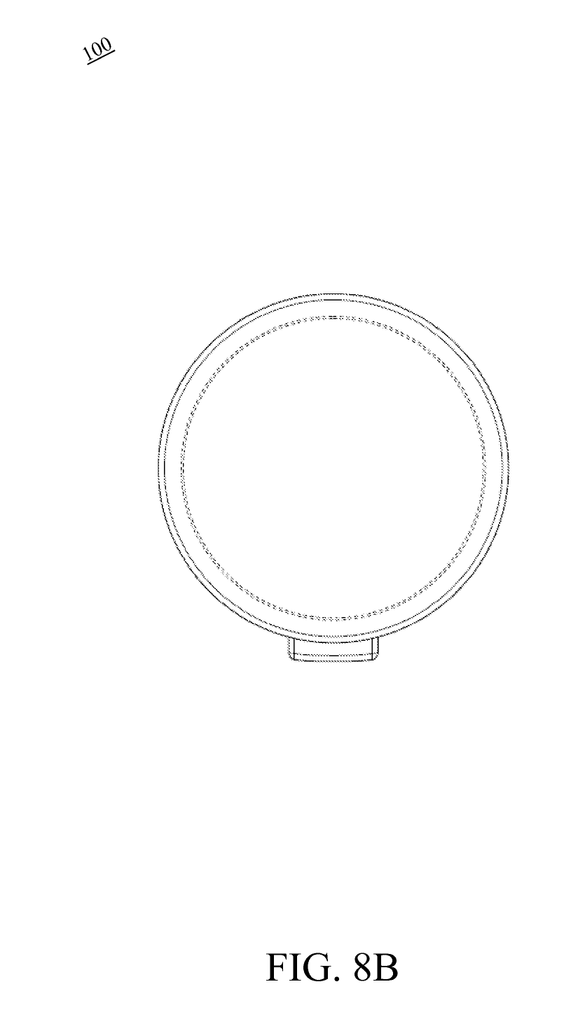

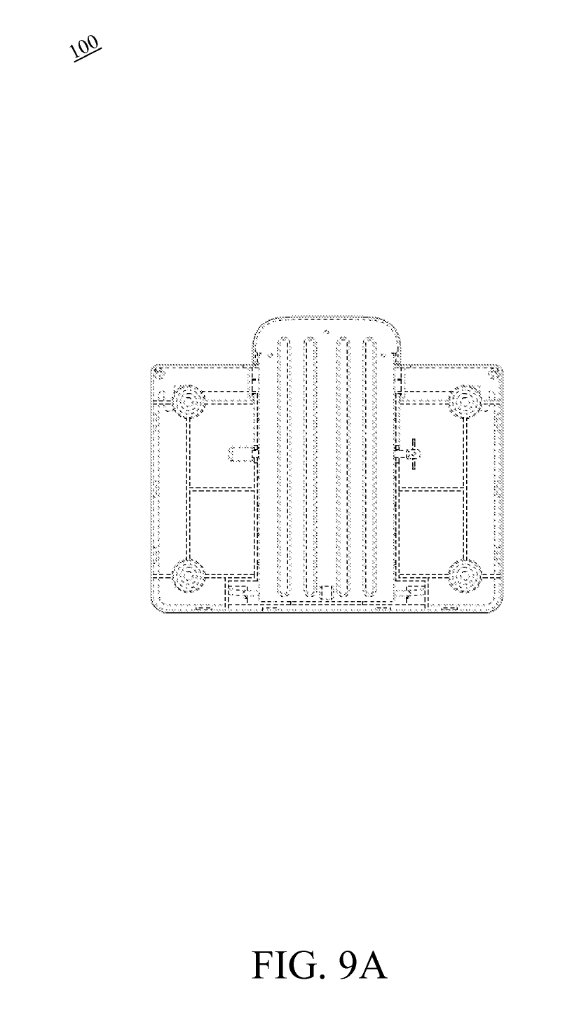

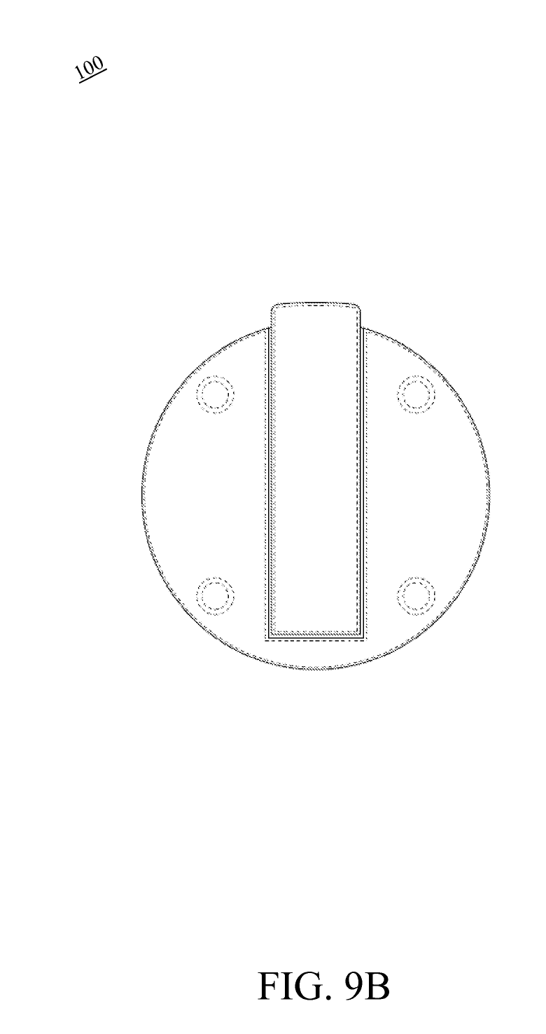

In exemplary embodiments, referring to FIGS. 3A-9B, trash dispenser 100 can have both lid 108 and gate 106 in a closed position. Further, in exemplary embodiments, the overall shape and trash dispenser 100 can be of aesthetic importance. For example, the aesthetics of trash dispenser 100 can be important as it may be located in the kitchen of a house, business environment, or other location where aesthetics may be important.

In exemplary embodiments, the cross-section of the trash dispenser can be any reasonable shape such as, but not limited to square, rectangular, polygonal, round, oval, any geometric shape, any further combination and/or separation thereof, and/or any other shape. For example, the at least one sidewall 101 extending vertically from a base 103 can create a body having a cross-section that can be any reasonable shape such as, but not limited to square, rectangular, polygonal, round, oval, any geometric shape, anthropomorphic shape, animal shape, fanciful shape, any further combination and/or separation thereof, and/or any other shape.

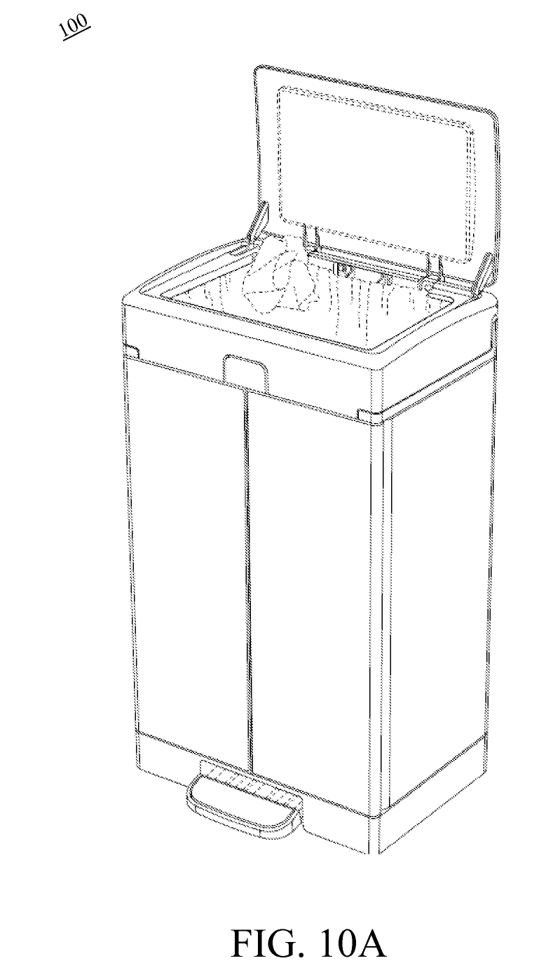

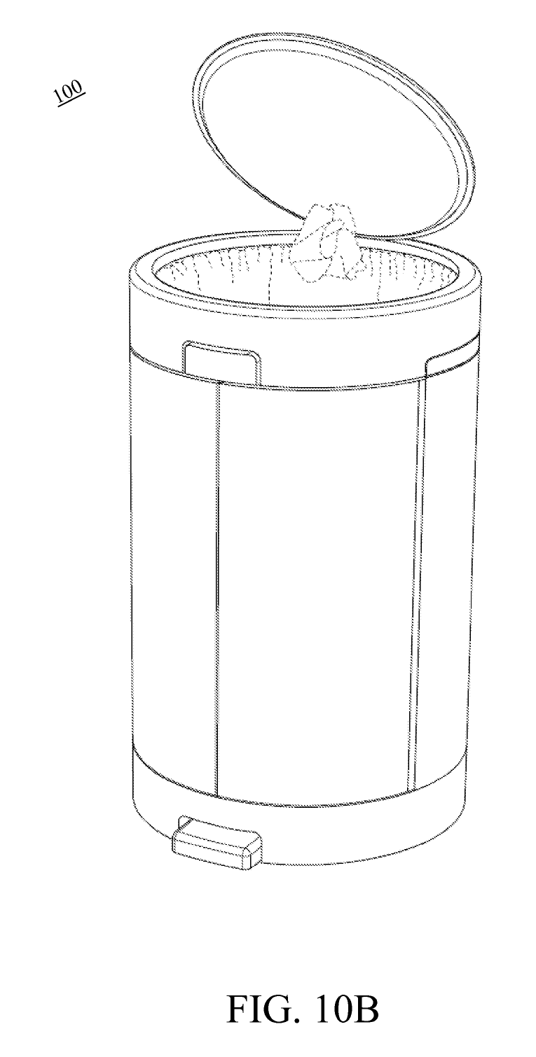

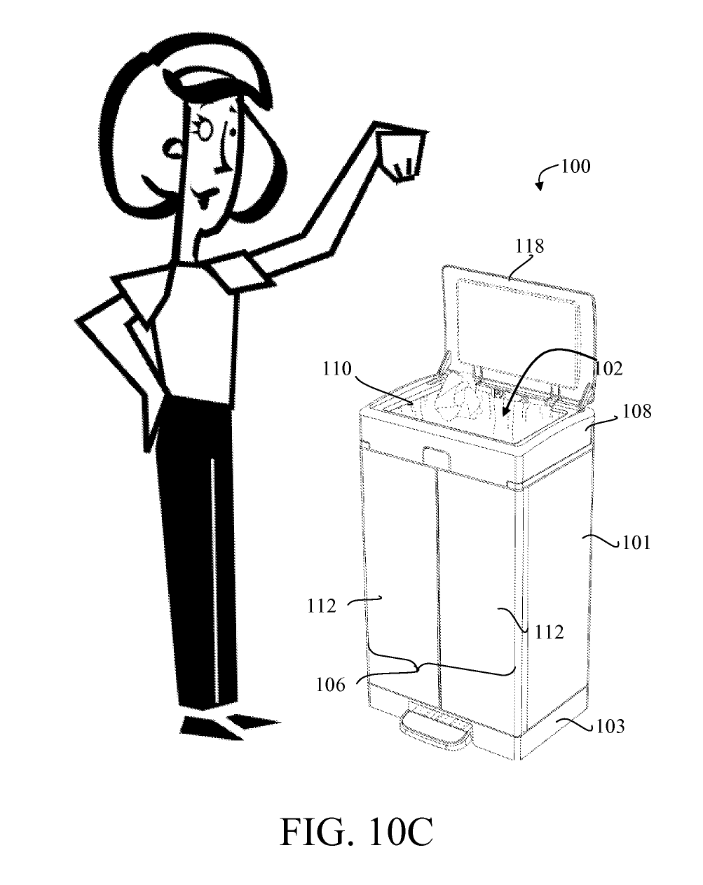

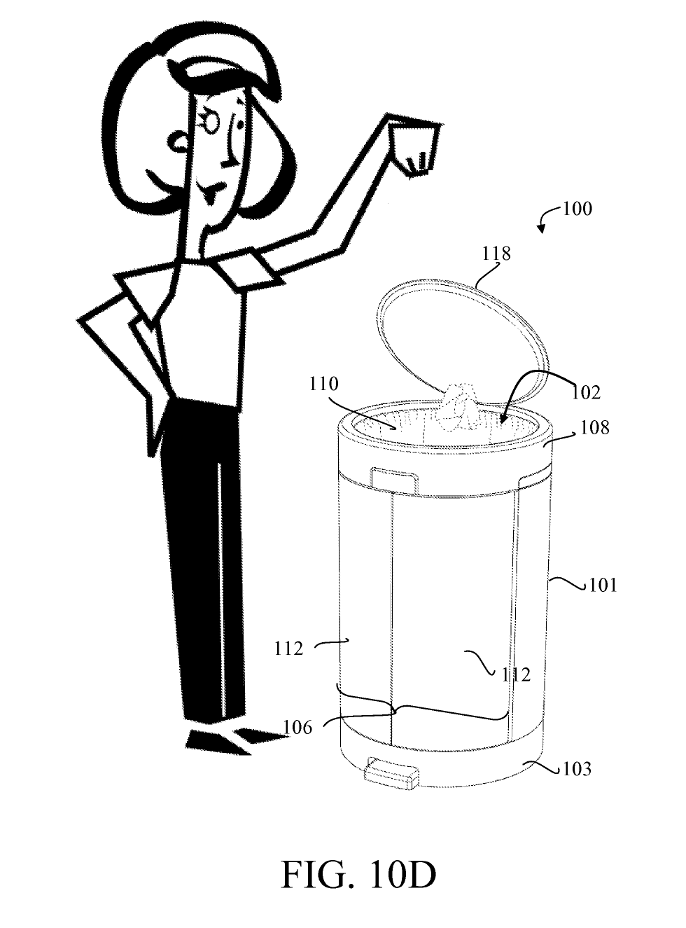

Referring to FIGS. 10A-10D, in exemplary embodiments, lid 108 can be displaced thereby opening the top region of trash dispenser 100 and/or exposing first opening 102 such that trash bag 110 is accessible. For example, referring to FIG. 10C-10D, with the top region of trash dispenser 100 opened a user can place rubbish into trash bag 110. When finished placing rubbish in trash bag 110, lid 108 can be displaced again thereby closing the dispenser such that trash bag 110 is no longer exposed. As this process is repeated trash bag 110 can become substantially full and/or may be heavy.

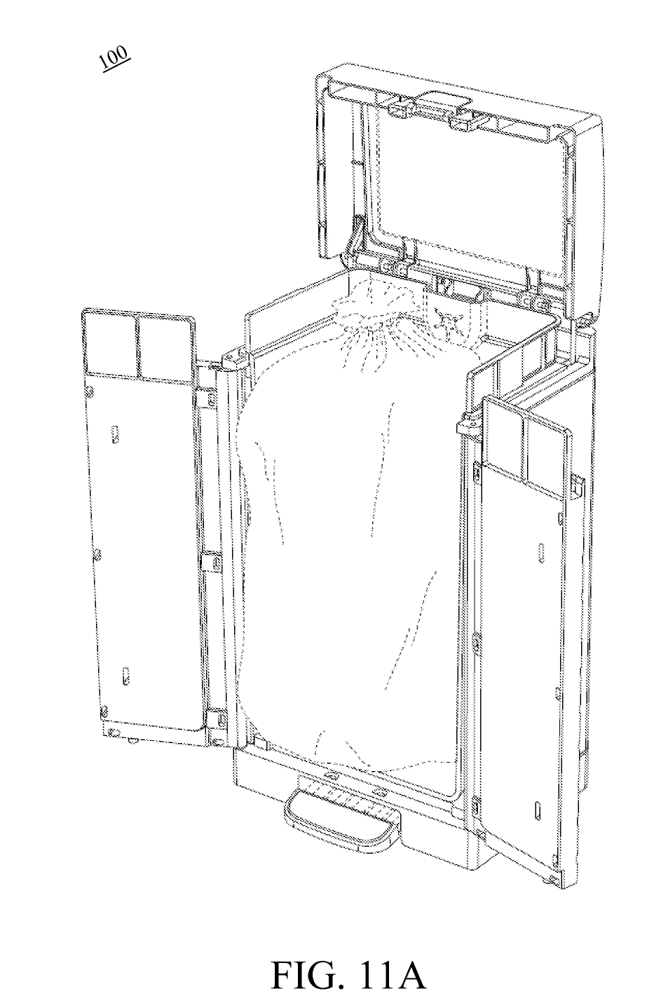

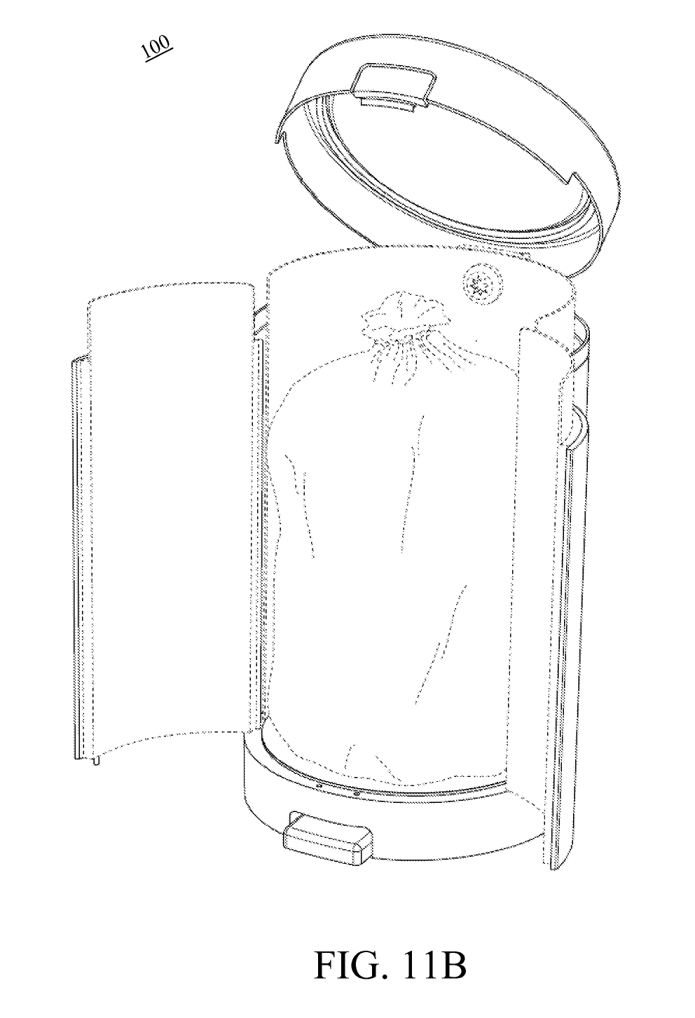

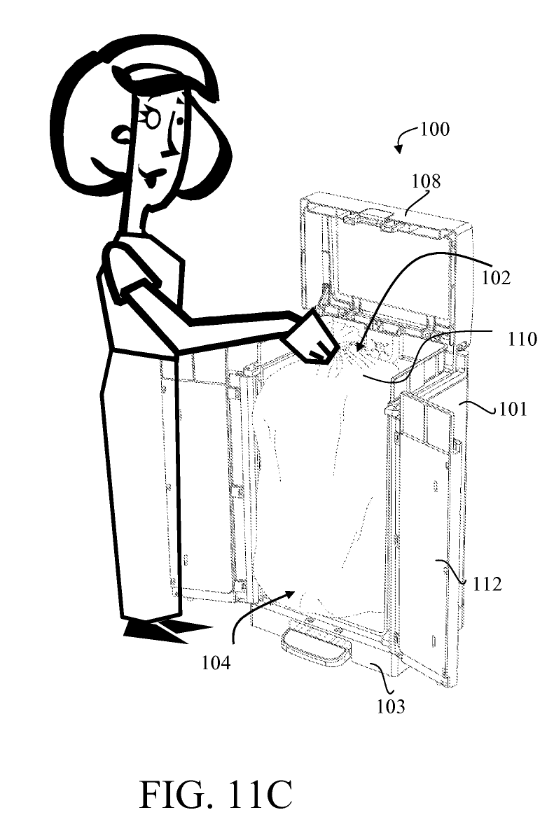

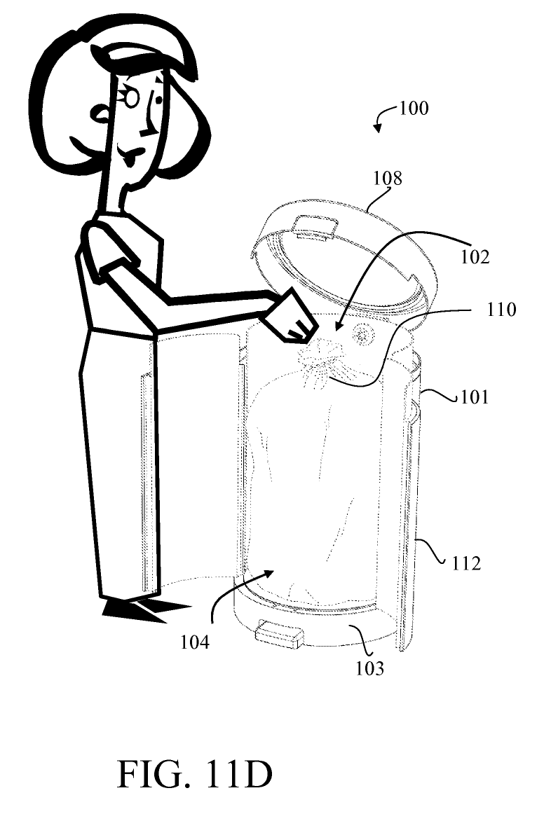

Referring to FIGS. 11A-11D, in exemplary embodiments, gate 106, located on at least some region of the sidewall of trash dispenser 100, can be displaced thereby opening the side region of trash dispenser 100 and/or exposing second opening 104 such that trash bag 110 can be accessible. Further, in exemplary embodiments, both gate 106 and lid 108 can be displaced such that trash dispenser 100 can be substantially opened and/or allowing trash bag 110 to be accessible. In exemplary embodiments, with both the top region and/or first opening 102 of trash dispenser 100 substantially opened as well as the side region and/or second opening 104 of trash dispenser 100 substantially opened, trash bag 110 can be substantially easier to access and/or substantially easier to remove from trash dispenser 100.

In exemplary embodiments, with both the side and top of trash dispenser 100 opened, trash bag 110 can be removed from trash dispenser 100 with substantially greater ease because, for example, a user can remove trash bag 110 from trash dispenser 100 substantially laterally at an offset angle from sidewall 101 and/or base 103 of trash dispenser 100 and/or not be restricted to lifting trash bag 110 solely vertically. For example, referring to FIGS. 11C-11D, trash bag 110 can removed from trash dispenser 100 in a substantially lateral technique. That is, a user may not be required to lift trash bag 110 solely vertically, for example, at a substantially parallel angle to the sidewall of the dispenser and/or substantially perpendicular angle to base 103 of trash dispenser 100. Rather, in exemplary embodiments, a user can remove trash bag 110 from trash dispenser 100 substantially laterally, for example, at an offset angle from sidewall 101 and/or base 103 of trash dispenser 100 and/or not be restricted to lifting trash bag 110 solely vertically.

In exemplary embodiments, gate 106 can include any reasonable movable barrier allowing access to trash bag 110 from at least one side of trash dispenser 100 such as, but not limited to a hinged door, a plurality of hinged doors, a sliding door, a plurality of sliding doors, a rotating door, and a plurality of rotating doors, to name a few. Further, the hinge can be located on any reasonable location such as, but not limited to, a single side of a sidewall, more than one side of a sidewall, and/or any other reasonable location for locating at least one hinge. For example, gate 106 can include a plurality of doors 112 extending at least partially along one side of trash dispenser 100 such that doors 112 can pivot exposing and/or providing access to trash bag 110. For example, gate 106 can include a plurality of saloon style doors 112 extending along one side of trash dispenser 100 that can pivot exposing and/or providing access to trash bag 110.

It will be understood that gate 106 can include any reasonable hinge, guide, and/or guide rail. Further, in exemplary embodiments, gate 106 can replace at least one sidewall of trash dispenser 100, all of the sidewall(s) of trash dispenser 100, and/or a region of at least one sidewall of trash dispenser 100.

In exemplary embodiments, lid 108 can include any reasonable cap capable of substantially covering and/or sealing first opening 102 of trash dispenser 100 and/or lid 108 can be coupled to and/or be able to separate from trash dispenser 100. For example, lid 108 can couple to and/or be able to separate from at least one sidewall 101 of trash dispenser 100 and/or any other component of trash dispenser 100. Further, lid 108 can be coupled to trash dispenser 100 such that lid 108 can act as a movable barrier that can allow access to trash bag 110 from the top of trash dispenser 100. For example, lid 108 can be coupled to the trash dispenser 100 by any number of hinges 120.

In exemplary embodiments, lid 108 can further include a displaceable opening 118 such that, for example, lid 108 can be coupled to trash dispenser 100 and/or displaceable opening 118 in lid 108 can provide access to trash bag 110. For example, displaceable opening 118 in lid 108 can be utilized to access trash bag 110 to dispose of rubbish. For another example, to remove trash bag 110, lid 108 may be moved and/or displaced in conjunction with gate 106 while displaceable opening 118 may only be used to access trash bag 110 to dispose of rubbish. In exemplary embodiments, lid 108 need not include a displaceable opening 118, such that access to the trash bag 110 can be directly accessed through lid 108.

Movement and/or displacement of gate 106, lid 108, displaceable opening 118, and/or doors 112 can be activated by any reasonable technique and/or force input, such as, but not limited to, a user provided force, a force from a motor or any other electro-mechanical device, and/or any other reasonable source capable of providing force to drive movement. For example, a user can provide force via a lever, a foot pedal, a button, or any other reasonable technique for a user to apply force.

In exemplary embodiments, force can be applied by a motor or any other electromechanical device in response to a sensor and/or in response to a user input. The sensor can be any reasonable sensor, such as, but not limited to a motion sensor, heat sensor, and/or moisture sensor. The user input can be any reasonable user input such as, but not limited to interaction with a button, sensor, screen, and/or pedal.

For ease, at times, gate 106, lid 108, displaceable opening 118, and/or doors 112 are described as being activated and/or opened by a user input applying a force on pedal 122. This is merely for ease and is in no way meant to be a limitation.

In exemplary embodiments, trash dispenser 100 can be constructed for use with any standard trash bag 100 and/or trash dispenser 100 can be constructed for use with a trash bag 100 designed specifically for use with trash dispenser 100.

In some instances, trash bag 110 can be releasably coupled to trash dispenser 100 by wrapping a portion of the trash bag over the periphery a trash bag retaining region 121 that can be separate from trash dispenser 100 and/or can be affiliated with, for example, first opening 102, gate(s) 106, door(s) 112, sidewall 101, any combination or separation thereof, and/or by being wrapped about any element affiliated with trash dispenser 100.

In exemplary embodiments, trash dispenser 100 can include a trash bag attachment fixture (not shown) such as, but not limited to, hooks, clasps, adhesive, a rod, and/or any other mechanism that can be releasably couple trash bag 110. By way of example, in exemplary embodiments, trash bag 110 can be releasably coupled to trash bag attachment fixture (not shown) of trash dispenser 100 by, for example, placing trash bag 110 on a rod, or by any other reasonable coupling technique.

It will be understood that trash bag 110 can be coupled to a region of trash dispenser 100, coupled to trash bag retaining region 121, coupled to at least one trash bag attachment fixture, and/or trash bag 110 can be coupled by any other reasonable technique for releasably coupling trash bag 110 to trash dispenser 100.

In exemplary embodiments, trash bag 110 can be removed and/or received via first opening 102 and/or second opening 104. For example, trash bag 110 can be placed into trash dispenser 100 through first opening 102 and/or releasably coupled to trash dispenser 100. As another example, trash bag 110 can be placed into trash dispenser 100 through second opening 104 and/or releasably coupled to trash dispenser 100.

In exemplary embodiments, trash bag 110 can be removed and/or received via first opening 102, second opening 104, and/or the combination of first opening 102 and second opening 104. For example, trash bag 110 can removed from trash dispenser 100 through first opening 102 and second opening 104 in combination such that trash bag 110 is substantially laterally removed from trash dispenser 100.

In exemplary embodiments, rubbish can be placed into trash bag 110 located within trash dispenser 100 via first opening 102 and/or displaceable opening 118. Further, trash bag 110 can be received from the top region of trash dispenser 100 through first opening 102, from the side region of trash dispenser 100 through second opening 104, and/or from a combination of the top region of trash dispenser 100 and side region of trash dispenser 100.

Any of the elements of trash dispenser 100 such as, but not limited to, sidewall(s) 101, base 103, first opening 102, second opening 104, gate(s) 106, lid(s) 108, door(s) 112, displaceable opening(s) 118, hinge(s) 120, force input(s), sensor(s), pedal(s) 122, trash bag retaining region 121, trash bag attachment fixture, and/or any other elements of trash dispenser 100 can be made from the same or different materials. Further, any of the elements of trash dispenser 100 such as, but not limited to, sidewall(s) 101, base 103, first opening 102, second opening 104, gate(s) 106, lid(s) 108, door(s) 112, displaceable opening(s) 118, hinge(s) 120, force input(s), sensor(s), pedal(s) 122, trash bag retaining region 121, trash bag attachment fixture, and/or any other elements of trash dispenser 100 can be made from any reasonable material, such as, but not limited to, plastics, metals, or any other combination thereof.

It will be understood that any of the elements of trash dispenser 100 such as, but not limited to, sidewall(s) 101, base 103, first opening 102, second opening 104, gate(s) 106, lid(s) 108, door(s) 112, displaceable opening(s) 118, hinge(s) 120, force input(s), sensor(s), pedal(s) 122, trash bag retaining region 121, trash bag attachment fixture, and/or any other elements of trash dispenser 100 can be further combined and/or separated without deviating from the scope of the invention.

Now that exemplary embodiments of the present invention have been shown and described in detail, various modifications and improvements thereon will become readily apparent to those skilled in the art. For example, in exemplary embodiments, the devices, systems, and methods disclosed herein can be used for other forms of containers and/or dispensers such as, but not limited to, laundry hampers. Similarly, receptacles other than trash bags could likewise be used such as other forms of bags, baskets or receptacles. Accordingly, the spirit and scope of the present invention is to be construed broadly and limited only by the appended claims, and not by the foregoing specification.

What is claimed is:

1. A trash dispenser system, comprising:
an at least one sidewall extending a vertical length from a base,
an at least one lid substantially covering a first opening, the first opening being located substantially near the top of the sidewall, wherein displacing the lid exposes the first opening;
an at least one gate substantially covering a second opening, the second opening being located along at least some region of the vertical length of the sidewall, wherein displacing the gate exposes the second opening; and
wherein at least one of the first opening and the second opening receive trash bags, displacing the lid allows receipt of rubbish via the first opening, and displacing the at least one gate allows substantially lateral removal of trash bags from the trash dispenser.

2. The trash dispenser of claim 1, wherein the gate is further comprising:
an at least one door coupled to the at least one sidewall by an at least one hinge.

3. The trash dispenser of claim 1, wherein the gate is a saloon style gate.

4. The trash dispenser of claim 1, wherein the gate is a door style gate with a hinge along at least one side of the door style gate.

5. The trash dispenser of claim 1, wherein the cross-section of the trash dispenser is at least one of square, rectangular, oval, round.

6. The trash dispenser of claim 1, wherein the cross-section of the trash dispenser is at least one of anthropomorphic shape, animal shape, fanciful shape

7. The trash dispenser of claim 1, where the gate substantially replaces at least one of (i) a region of the sidewall of the trash dispenser and (ii) the sidewall of the trash dispenser.

8. The trash dispenser of claim 1, wherein the substantially lateral removal of trash bags from the trash dispenser allows removal of trash bags from the trash dispenser at an offset angle from at least one of the sidewall and the base of the trash dispenser.

9. The trash dispenser of claim 1, wherein the lid is at least one of coupled to the sidewall and removable from the sidewall.

10. The trash dispenser of claim 9, wherein the lid is coupled to the sidewall by an at least one hinge.

11. The trash dispenser of claim 9, wherein the lid is further comprising at least one displaceable opening.

12. The trash dispenser of claim 1, wherein a displaceable opening is coupled to at least one of the lid and the sidewall by at least one hinge.

13. The trash dispenser of claim 11, wherein the trash dispenser is further comprising:
a force input, and
wherein displacing at least one of the lid, gate, and displaceable opening is activated by the force input.

14. The trash dispenser of claim 13, wherein the force input is at least one of a lever, a foot pedal, and a button.

15. The trash dispenser of claim 13, wherein the force input is a motor.

16. The trash dispenser of claim 15, wherein the trash dispenser is further comprising:
an at least one sensor; and
wherein the motor is activated in response to the sensor.

17. The trash dispenser of claim 1, wherein the trash dispenser is further comprising:
at least one of a trash bag retaining region and trash bag attachment fixture.

18. The trash dispenser of claim 17, wherein the trash bag attachment fixture is further comprising:
at least one hooks, clasps, adhesive, and rod.

19. The trash dispenser of claim 17, wherein the trash bag retaining region retains the trash bag by wrapping a portion of the trash bag over a portion of the trash dispenser.

20. The trash dispenser of claim 17, wherein the trash bag retaining region retains the trash bag by wrapping a portion of the trash bag over a periphery of first opening.
